(19) United States
(12) Patent Application Publication
(10) Pub. No.: US 2004/0073418 A1
(43) Pub. Date: Apr. 15, 2004

(54) Method and system for modeling of effective capacitance in logic circuits

(75) Inventor: Sani Richard Nassif, Austin, TX (US)

Correspondence Address: Andrew M. Harris, Weiss, Moy & Harris, P.C., 4204 North Brown Ave., Scottsdale, AZ, 85251-3914, US

(73) Assignee: International Business Machines Corporation, Armonk, NY

(21) Appl. No.: 10/268,235

(22) Filed: Oct. 10, 2002

(51) Int. Cl. G06F 17/50

(52) U.S. Cl. 703/19

(57) ABSTRACT

A method and system for modeling effective capacitance of logic circuits provides accuracy without iteration and an improved understanding of logical circuit block performance variation with implementation changes. An effective output capacitance of a logical circuit output node is calculated. The equivalent resistance of the output node is determined by modeling at least one of the output transistors using a transfer conductance model relating the input voltage function to the output current. The values in a pi-network model of the output impedance are determined from circuit design parameters relating the distributed resistance to the equivalent resistance of the output transistor and relating the distributed capacitance of the output transistor and relating the distributed capacitance to the two capacitances in the pi-network. The effective output then capacitance is determined by equating the time delays of the pi-network model and a simple parallel RC combination.

### BACKGROUND OF THE INVENTION

1. Field of the Invention

The present invention generally relates to systems for modeling the behavior of integrated circuits such as verifiers, simulators and design tools, and more particularly to a computer program that includes modeling of digital integrated circuit output effective capacitance loading.

2. Description of Related Art

Design tools and verification tools are necessary for modeling large-scale digital integrated circuits such as Very Large Scale Integration (VLSI) circuits. Billions of transistors and logic gates are often combined on a single die and the performance of the die is modeled using software that models the performance of the overall die based on known (modeled) performance of individual gates, inverter/buffer models of gates, or models of larger functional blocks.

Determining the effective capacitance at logical circuit output nodes is used to calculate power supply current requirements, output rise time and delay, and may be used as well in noise and thermal performance calculations. The effective capacitance at an output is a sum of capacitive loads on a logic circuit output node, which include: logic inputs to which the output node is connected, interconnect line capacitance and capacitance of the output stage transistors.

As improvements in device technology are introduced, the effect is to scale down the overall die and logic block size. The impact on effective capacitance calculations is that the reduced interconnect size leads to increased resistance of the interconnect lines, as well as increased resistance of the output stage transistor. The interconnect and output stage resistance must be taken into account in the modeling of the connected input capacitance and to some degree in the modeling of the interconnect line capacitance, especially as the interconnect and output resistance increase due to technology scaling.

Present techniques for modeling effective capacitance of logic circuit output nodes either ignore or estimate the interconnect resistance, providing simplified models that inaccurately estimate the logic circuit output resistance. More accurate models use iterative techniques that do not provide a direct understanding of the changes in effective capacitance or logic circuit performance that occur due to changes in the interconnect and output resistance.

Therefore, it is desirable to implement an improved effective capacitance modeling algorithm. It would further be desirable to provide an algorithm that provides a direct understanding of circuit performance changes due to circuit implementation changes and is not iterative.

### SUMMARY OF THE INVENTION

The objective of providing an improved effective capacitance modeling algorithm that is not iterative and provides an understanding of logic block performance variation with implementation changes is achieved in a method for modeling effective output capacitance of a logical circuit block. The method calculates an effective capacitance by determining a lumped capacitance connected to the output load and computing an output resistance of the output stage connected to the output node. The effective capacitance is determined using a pi-network model that includes a model series resistance between two capacitances forming fractional parts of the lumped capacitance. The ratio of the effective capacitance to the lumped capacitance is determined by equating a time delay for the pi network with the time delay for a parallel combination of the effective output capacitance with the effective output resistance.

The effective output resistance may be computed by a modeling a transfer conductance of said output stage over an input voltage function applied to the output stage transistors and solving an equation that equates a time delay determined from the transfer conductance model with a time delay of a parallel combination of the lumped output capacitance with the effective resistance.

The invention may further be embodied in a workstation computer executing program instructions for carrying out the steps of the method, and in a computer program product having a storage media for those program instructions. The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a pictorial diagram of a workstation computer system in which methods in accordance with an embodiment of the present invention are performed.

FIGS. 2A-2D are circuit diagrams showing transformation of a logical circuit block model to a model in accordance with the present invention.

FIG. 4 is a flowchart depicting a model in accordance with an embodiment of the present invention.

FIG. 5 is a graph of simulation data corroborating accuracy of a model in accordance with an embodiment of the present invention.

### DETAILED DESCRIPTION OF PREFERRED EMBODIMENT

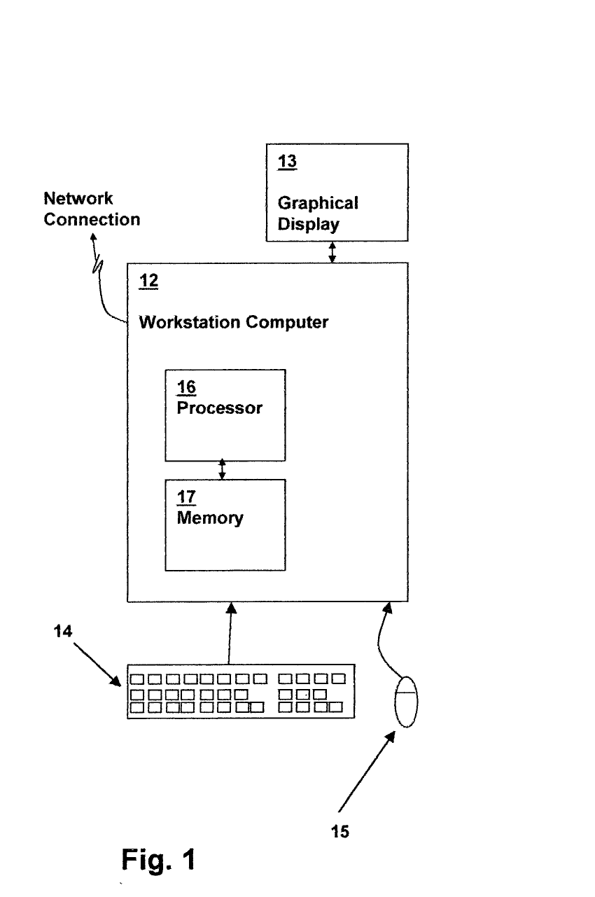

Referring to the figures, and particularly to FIG. 1, a workstation computer system, in which methods according to an embodiment of the present invention are performed, is depicted. A workstation computer 12, having a processor 16 coupled to a memory 17, for executing program instructions from memory 17, wherein the program instructions include program instructions for executing one or more methods in accordance with an embodiment of the present invention.

Workstation computer 12 is coupled to a graphical display 13 for displaying program output such as simulation results and circuit structure input and verification programs implementing embodiments of the present invention. Workstation computer 12 is further coupled to input devices such as a mouse 15 and a keyboard 14 for receiving user input. Workstation computer may be coupled to a public network such as the Internet, or may be a private network such as the various “intra-nets” and software containing program instructions embodying methods in accordance with embodiments of the present invention may be located on remote computers or locally within workstation computer 12.

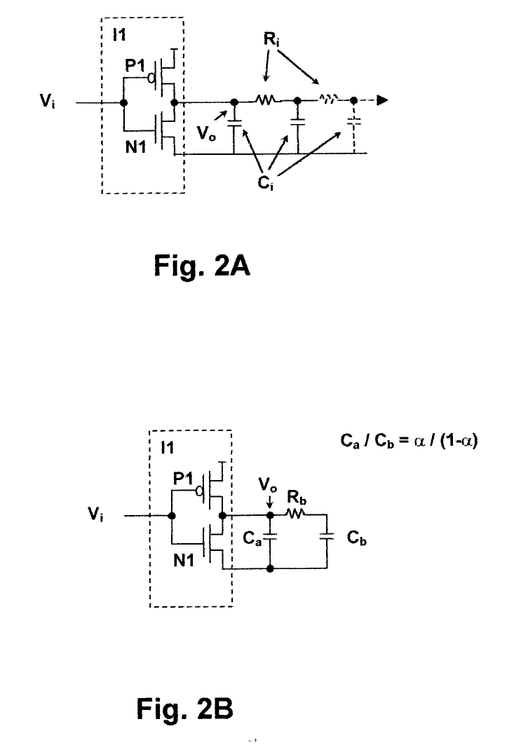

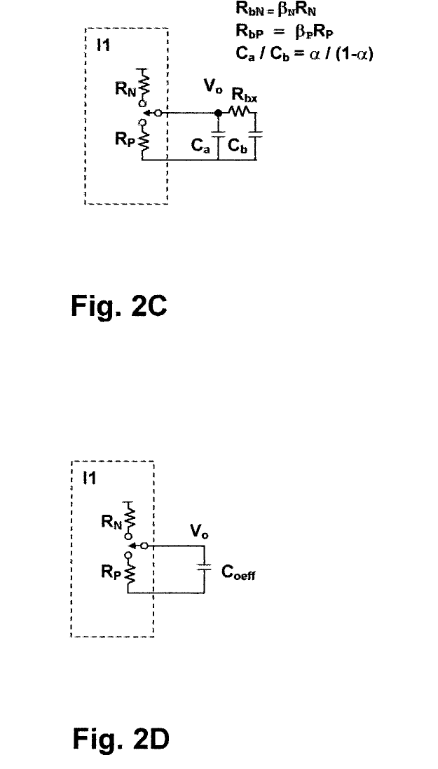

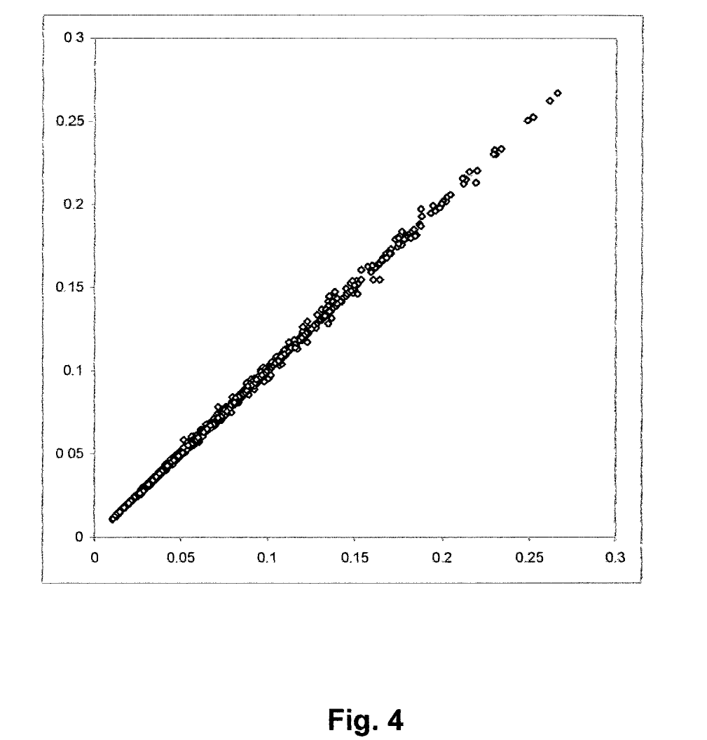

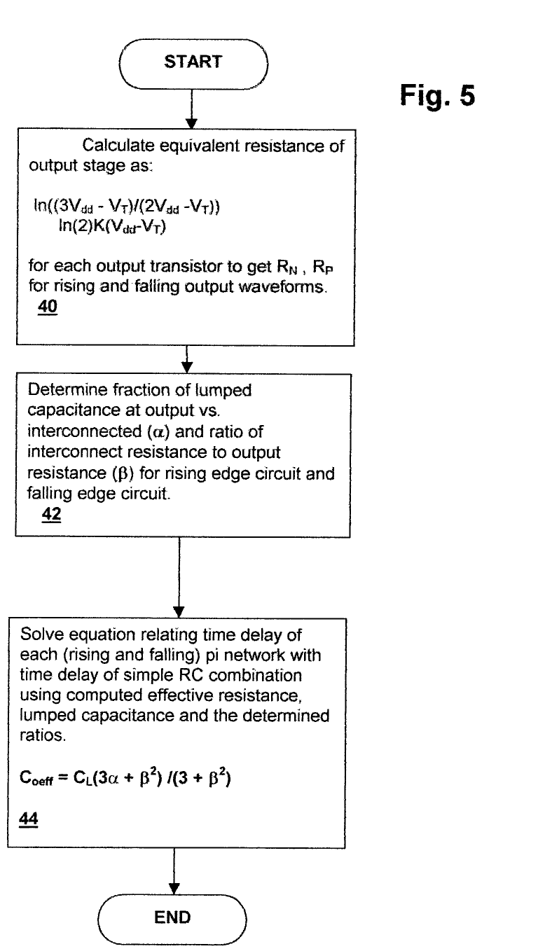

Referring now to FIG. 2A, a schematic diagram of a circuit block model is depicted. Inverter I1 is used as an exemplary illustration, but this does not limit the scope of application of the techniques of the present invention. Any logical circuit block output may be modeled using methods in accordance with embodiments of the present invention, and the structure to which the output node of the circuit block is connected may be any structure, as long as it may be represented as a resistor/capacitor network (e.g., capacitive loading as opposed to inductive). The load depicted in FIG. 2A includes a plurality of capacitances C_{I} a plurality of resistances R_{I} connected to the output of inverter I1. Resistances R_{I} and capacitances C_{I} represent the distributed resistances and capacitances present in an actual circuit coupled to inverter I1, which may branch to numerous logic inputs, external pins and external circuits. The total of capacitances C_{I} is the DC lumped capacitance C_{L}, which also includes the output capacitance of inverter I1.

The model of the present invention reduces the output node loading model to a combination of a single effective load capacitance C_{oeff} and a single equivalent output resistance R_{oeff}, for each of the charging and discharging transitions inverter I1 output. The separate models for charging and discharging are needed due to the differences in characteristics of transistors N1 and P1.

R_{oeff} is due to the output resistance (conductance) of the transistors N1 and P1 and is modeled as equal to the equivalent resistance of the output stage of inverter I1. C_{oeff} is due to the output capacitance of transistors N1 and P1 as well as the distributed capacitive loading at inputs to which the output of inverter I1 is connected, but is not merely equal to lumped capacitance C_{L}, as the contribution of the load capacitances is decreased by the interconnect resistance. The effect of the interconnect resistance is thus modeled as a reduction in C_{oeff} from lumped capacitance C_{L}.

Referring now to FIG. 2B, a transformation of the circuit block model of FIG. 2A is depicted. Here, the lumped capacitance at the output of inverter I1 is represented by two capacitors: Cₐ and C_{b} in a pi-network model. Pi-network models of a logical circuit block output are described by P. R. O'brien and L. T. Savarino in “Modeling of Driving Point Characteristic of Resistive Interconnect for Accurate Delay Estimation”, Proceedings of the ICCAD, 1989.

The lumped capacitance (all of the static capacitance connected to the output node plus the transistor capacitance) is divided into two portions Cₐ and C_{b} with a ratio determined by a circuit factor α: so that Cₐ/C_{b}=α/(1−α). Fractional model ratio α is determined from design parameters from the output capacitance of the output stage and the total load capacitance connected. Resistance R_{b} is determined from the design parameters of the circuit and a ratio β represents the ratio of resistance due to the interconnects R_{b} and the output resistance (equivalent resistance) of the output stage transistors. Referring to FIG. 2C, transistors N1 and P1 are replaced by the equivalent output resistance of transistors P1 and N1, as shown selected via a switch.

The model of the present invention calculates C_{oeff} by matching the delay times (rising and fallings of the pi-network circuit shown in FIG. 2C and a simplified circuit model shown in FIG. 2D. Forcing a match (for each transition direction) between the times at which the output voltages of the circuits of FIG. 2C and FIG. 2D reach V_{dd}/2 (half of the supply voltage), a first order circuit having an equal delay time is found to generate the effective capacitance. The ratio of the effective capacitance C_{oeff} to the lumped capacitance C_{L} is given as η and used to formulate an expression for η dependent only on α and β.

Equating the 50% delay times for the circuit of FIG. 2C and the circuit of FIG. 2D yields a non-linear equation. An excellent estimate of the solution is: η=(3α+β²)/(3+β²).

Once η is known, the resulting effective capacitance is calculated as C_{oeff}=ηC_{L}, yielding an improved effective capacitance for the circuit model.

In order to perform the above computations, the equivalent resistances R_{N} and R_{P} (of FIG. 2C) must be known for the output of the logical circuit block, as well as the interconnect series resistance leading to resistance R_{bx} (R_{bN} for transistor N1 on a rising transition of the output and R_{bP} for transistor P1 on a falling transition of the output). A model in accordance with an embodiment of the present invention provides equivalent resistances R_{N} and R_{P} for use in the above calculations.

The Schichman-Hodges MOSFET model (as used in SPICE simulation) provides:

$${I}_{ds} = \{ \begin{matrix}0 & : & {V}_{gs} < {V}_{T} \\ {K ( {V}_{gs} - {V}_{T} )}^{2} & : & {V}_{ds} > {V}_{gs} - {V}_{T} \\ 2 {KV}_{ds} ( {V}_{gs} - {V}_{T} - {V}_{ds} / 2 ) & : & {V}_{ds} < {V}_{gs} - {V}_{T}\end{matrix} \}$$

where K is the transistor device constant and V_{T} is the transistor threshold voltage.

The equivalent output resistance for a single MOSFET charging or discharging a single capacitance with a step input is well estimated by:

R=ln((3V_{dd}−4V_{T})/(V_{dd}−2V_{T}))/(ln(2)K(V_{dd}−V_{T}))

The equivalent resistances R_{N} and R_{P} can then be calculated (knowing K and V_{T} for each transistor) and used in the equations for effective capacitance disclosed above. Simulations have yielded a mean error of less than 1 percent and a standard deviation of less than 2 percent over a wide range of circuit and power supply conditions. FIG. 3 shows a graph of the data

What is claimed is:

1. A method for modeling output node characteristics of a logical circuit block, comprising:
determining a lumped capacitance (C_{L}) at said output node from design parameters of said logical circuit block;
determining an equivalent output resistance of an output node transistor (R_{N} or R_{P}) from said design parameters;
modeling a first model circuit of said output node, said first model circuit representing a distribution of said lumped capacitance;
equating a first time delay of said first model circuit to a second time delay of a second model RC circuit consisting of a resistance equal to said equivalent resistance in parallel with a capacitance equal to an effective capacitance; and
solving for said effective capacitance from a result of said equating.

2. The method of claim 1, wherein said modeling models a first model circuit comprising a pi network consisting of a model series resistance (R_{b}), having a first shunt capacitance (Cₐ) connected to a first terminal of said series resistance equal to said lumped capacitance minus a fractional model portion of said lumped capacitance, and a second shunt capacitance (C_{b}) connected to a second terminal of said series resistance equal to said fractional model portion of said lumped capacitance.

3. The method of claim 2, wherein said equating comprises:
calculating a first ratio (β) between said equivalent output resistance and said model series resistance; and
second calculating a second ratio (α) of said lumped capacitance minus said fractional model portion of said lumped capacitance, and wherein said solving is performed by computing a third ratio (η) of an effective capacitance (C_{oeff}) to said lumped capacitance, whereby said effective capacitance may be determined from said lumped capacitance.

4. The method of claim 3, wherein said first delay and said second time delay constant represent times at which said associated model circuits reach one-half of a supply voltage of said logical circuit block.

5. The method of claim 3, wherein said third ratio is computed according to:
multiplying said second ratio by a factor of three;
adding the square of said first ratio to obtain a numerator result;
adding three to said square of said first ratio to obtain a denominator result; and
dividing said numerator by said denominator to obtain said third ratio.

6. The method of claim 1, wherein said determining said equivalent output resistance determines an output resistance of an output stage of said logical circuit block by:
modeling a transfer conductance of said output stage over an input voltage function applied to at least one transistor of said output stage; and
computing said equivalent output resistance by determining a solution of an equation equating a fourth time delay constant of a parallel combination of said equivalent output resistance and said lumped capacitance with a third time delay constant determined in conformity with said transfer conductance model.

7. The method of claim 6, wherein said input voltage function is a step function, said computing said equivalent output resistance is performed in a simplified calculation relating said equivalent output resistance as a function of a threshold voltage of said at least one output transistor, a device constant of said at least one output transistor and a supply voltage of said output stage.

8. The method of claim 7, wherein said equivalent output resistance is computed according to:
R_{oeff}=ln((3V_{dd}−4V_{NT})/(2V_{dd}−2V_{NT}))/ln(2)K_{N}(V_{dd}−V_{NT})
wherein
R_{oeff} is said equivalent output resistance,
ln is a natural logarithm function,
V_{dd} is said supply voltage,
V_{NT} is said threshold voltage, and
K_{N} is said device constant.

9. A computer program product for use with a workstation computer, wherein said computer program product comprises signal bearing media containing program instructions for execution within said workstation computer for modeling output node characteristics of a logical circuit block, wherein said program instructions comprise program instructions for:
determining a lumped capacitance (C_{L}) at said output node from design parameters of said logical circuit block;
determining an equivalent output resistance of an output node transistor (R_{N} or R_{P}) from said design parameters;
modeling a first model circuit of said output node, said first model circuit representing a distribution of said lumped capacitance;
equating a first time delay of said first model circuit to a second time delay of a second model RC circuit consisting of a resistance equal to said equivalent resistance in parallel with a capacitance equal to an effective capacitance; and
solving for said effective capacitance from a result of said equating.

10. The computer program product of claim 9, wherein said program instructions for modeling model a first model circuit comprising a pi network consisting of a model series resistance (R_{b}), having a first shunt capacitance (Cₐ) connected to a first terminal of said series resistance equal to said lumped capacitance minus a fractional model portion of said lumped capacitance, and a second shunt capacitance (C_{b}) connected to a second terminal of said series resistance equal to said fractional model portion of said lumped capacitance.

11. The computer program product of claim 10, wherein said program instructions for equating comprise program instructions for:
calculating a first ratio (β) between said equivalent output resistance and said model series resistance; and
second calculation a second ratio (α) of said lumped capacitance minus said fractional model portion of said lumped capacitance, and wherein said program instructions for solving compute a third ratio (η) of an effective capacitance (C_{oeff}) to said lumped capacitance, whereby said effective capacitance may be determined from said lumped capacitance.

12. The computer program product of claim 11, wherein said first time delay and said second time delay constant represent times at which said associated model circuits reach one-half of a supply voltage of said logical circuit block.

13. The computer program product of claim 11, wherein program instructions for computing said third ratio comprise program instructions for:
multiplying said second ratio by a factor of three;
adding the square of said first ratio to obtain a numerator result;
adding three to said square of said first ratio to obtain a denominator result; and
dividing said numerator by said denominator to obtain said third ratio.

14. The computer program product of claim 9, wherein said program instructions for determining said equivalent output resistance determine an output resistance of an output stage of said logical circuit block by:
modeling a transfer conductance of said output stage over an input voltage function applied to at least one transistor of said output stage; and
computing said equivalent output resistance by determining a solution of an equation equating a fourth time delay constant of a parallel combination of said equivalent output resistance and said lumped capacitance with a third time delay constant determined in conformity with said transfer conductance model.

15. The computer program product of claim 14, wherein said input voltage function is a step function, and program instructions for computing said equivalent output resistance perform a simplified calculation relating said equivalent output resistance as a function of a threshold voltage of said at least one output transistor, a device constant of said at least one output transistor and a supply voltage of said output stage.

16. The computer program product of claim 15, wherein said program instructions for computing said equivalent output resistance compute said equivalent resistance according to:
R_{oeff}=ln((3V_{dd}−4V_{NT})/(2V_{dd}−2V_{NT}))/ln(2)K_{N}(V_{dd}−V_{NT})
wherein
R_{oeff} is said equivalent output resistance,
ln is a natural logarithm function,
V_{dd} is said supply voltage,
V_{NT} is said threshold voltage, and
K_{N} is said device constant.

17. A workstation comprising:
a memory for storing program instructions and data values for modeling characteristics of a logical circuit block;
a processor for executing said program instructions, wherein said program instructions comprise program instructions for
determining a lumped capacitance (C_{L}) at said output node from design parameters of said logical circuit block;
determining an equivalent output resistance of an output node transistor (R_{N} or R_{P}) from said design parameters;
modeling a first model circuit of said output node, said first model circuit representing a distribution of said lumped capacitance;
equating a first time delay of said first model circuit to a second time delay of a second model RC circuit consisting of a resistance equal to said equivalent resistance in parallel with a capacitance equal to an effective capacitance; and
solving for said effective capacitance from a result of said equating.

18. The workstation of claim 17, wherein said program instructions for modeling model a first model circuit comprising a pi network consisting of a model series resistance (R_{b}), having a first shunt capacitance (Cₐ) connected to a first terminal of said series resistance equal to said lumped capacitance minus a fractional model portion of said lumped capacitance, and a second shunt capacitance (C_{b}) connected to a second terminal of said series resistance equal to said fractional model portion of said lumped capacitance.

19. The workstation of claim 18, wherein said program instructions for equating comprise program instructions for:
calculating a first ratio (β) between said equivalent output resistance and said model series resistance; and
second calculating a second ratio (α) of said lumped capacitance minus said fractional model portion of said lumped capacitance, and wherein said program instructions for solving compute a third ratio (η) of an effective capacitance (C_{oeff}) to said lumped capacitance, whereby said effective capacitance may be determined from said lumped capacitance.

20. The workstation of claim 19, wherein said first time delay and said second time delay constant represent times at which said associated model circuits reach one-half of a supply voltage of said logical circuit block.

21. The workstation of claim 19, wherein program instructions for computing said third ratio comprise program instruction for:
multiplying said second ratio by a factor of three;
adding the square of said first ratio to obtain a numerator result;
adding three to said square of said first ratio to obtain a denominator result; and
dividing said numerator by said denominator to obtain said third ratio.

22. The workstation of claim 17, wherein said program instructions for determining said equivalent output resistance determine an output resistance of an output stage of said logical circuit block by:
modeling a transfer conductance of said output stage over an input voltage function applied to at least one transistor of said output stage; and
computing said equivalent output resistance by determining a solution of an equation equating a fourth time delay constant of a parallel combination of said equivalent output resistance and said lumped capacitance with a third time delay constant determined in conformity with said transfer conductance model.

23. The workstation of claim 21, wherein said input voltage function is a step function, and program instructions for computing said equivalent output resistance perform a simplified calculation relating said equivalent output resistance as a function of a threshold voltage of said at least one output transistor, a device constant of said at least one output transistor and a supply voltage of said output stage.

24. The workstation of claim 22, wherein said program instructions for computing said equivalent output resistance compute said equivalent resistance according to:
R_{oeff}=ln((3V_{dd}−4V_{NT})/(2V_{dd}−2V_{NT})/ln(2)K_{N}(V_{dd}−V_{NT})
wherein
R_{oeff} is said equivalent output resistance,
ln is a natural logarithm function,
V_{dd} is said supply voltage,
V_{NT} is said threshold voltage, and
K_{N} is said device constant.
